(19) United States
(12) Patent Application Publication
(10) Pub. No.: US 2026/0316867 A1
(43) Pub. Date: Oct. 15, 2026

(54) RADIATOR COVER

(71) Applicant: SUZUKI MOTOR CORPORATION, Hamamatsu-shi (JP)

(72) Inventor: Kaito TAKAHASHI, Hamamatsu-shi (JP)

(73) Assignee: SUZUKI MOTOR CORPORATION, Hamamatsu-shi (JP)

(21) Appl. No.: 19/571,130

(22) Filed: Mar. 18, 2026

(30) Foreign Application Priority Data
Apr. 11, 2025 (JP) 2025-065730

(51) Int. Cl. B62J 17/00; B60K 11/04

(52) U.S. Cl. CPC B62J 17/00; B60K 11/04

(57) ABSTRACT

A radiator cover for covering one side of a radiator on a radiator cap side in which the radiator is installed in front of an engine of a straddle-type vehicle is provided. The radiator cover includes a cover body having an insertion hole for receiving a protrusion protruding forward from the one side, and a restricting portion for restricting a forward displacement of the protrusion that extends through the insertion hole.

### CROSS-REFERENCE TO RELATED APPLICATIONS

This application is based on and claims priority under 35 USC 119 from Japanese Patent Application No. 2025-065730 filed on Apr. 11, 2025, the contents of which are incorporated herein by reference.

### BACKGROUND

The present invention relates to a radiator cover.

Known is a straddle-type vehicle that includes a radiator cover that covers a radiator in front of an engine from the side (refer to, for example, JP2008-222079A). A radiator cap is provided on an upper tank of the radiator described in JP2008-222079A, and the radiator cap is attached and detached for inspection or refill of a coolant in the radiator. A sufficient working space is ensured inside the radiator cover, thereby allowing easy installation and removal of the radiator cap. The radiator cover not only functions as an exterior component that improves an appearance of the vehicle, but also has a function of directing traveling wind taken into the cover toward the radiator.

### SUMMARY

According to an advantageous aspect of an invention, there is provided a radiator cover of the present invention, provided is a radiator cover for covering one side of a radiator on a radiator cap side in which the radiator is installed in front of an engine of a straddle-type vehicle, the radiator cover including a cover body having an insertion hole configured to receive a protrusion protruding forward from the one side, and a restricting portion configured to restrict a forward displacement of the protrusion that extends through the insertion hole, thereby solving the problem described above.

### BRIEF DESCRIPTION OF DRAWINGS

FIG. 1 is a right side view of a straddle-type vehicle according to an example.

FIG. 2 is a perspective view of an installation structure of a radiator cover of the example.

FIG. 3 is a perspective view of the installation structure of the radiator cover of the example.

FIG. 4 is a right side view of the installation structure of the radiator cover of the example.

FIG. 5 is a cross-sectional view of the installation structure of the radiator cover illustrated in FIG. 4 taken along a line A-A.

FIG. 6 is a cross-sectional view of a restricting portion illustrated in FIG. 5 taken along a line B-B.

### DETAILED DESCRIPTION OF EXEMPLIFIED EMBODIMENTS

The radiator cover described in JP2008-222079A has a voluminous design that largely covers and conceals the radiator cap having a circular lid shape. A radiator cover with a slim design is desirable, but it is difficult to form a radiator cover along a radiator cap.

The present invention has been made in view of the above points, and an object of the invention is to provide a radiator cover with a slim design.

A radiator is installed in front of an engine of a straddle-type vehicle according to an aspect of the present invention, and one side of the radiator on a radiator cap side is covered by a radiator cover. A protrusion protrudes forward from the one side of the radiator, and an insertion hole for receiving the protrusion is formed on a cover body of the radiator cover. The protrusion extends through the insertion hole, and a forward displacement of the protrusion is restricted by the restricting portion, thereby preventing misalignment between the radiator and the radiator cover. Even when the radiator and the radiator cover are not fixed, a positional relationship between the radiator and the radiator cover is maintained, so the radiator cover does not interfere with the radiator cap even when the radiator cover is formed along the radiator cap. Accordingly, the radiator cover can be formed along the radiator cap and with a slim design.

### Example

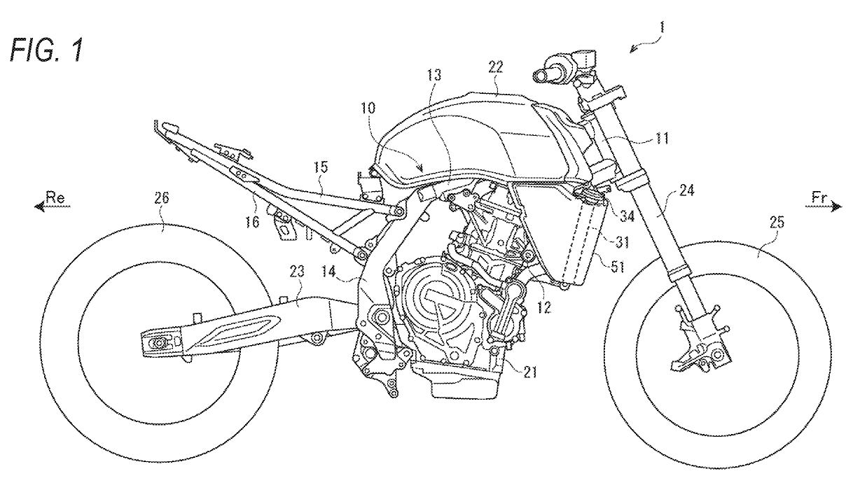

A straddle-type vehicle employing an installation structure of a radiator cover of the example will be described below with reference to the accompanying drawings. FIG. 1 is a right side view of a straddle-type vehicle according to the example. In the following drawings, an arrow Fr indicates a front side of the vehicle, an arrow Re indicates a rear side of the vehicle, an arrow L indicates a left side of the vehicle, and an arrow R indicates a right side of the vehicle.

As illustrated in FIG. 1, a straddle-type vehicle 1 is configured by mounting an engine 21, an electrical system, and other various components on a body frame 10. A head pipe 11 is provided at a front end of the body frame 10, and a pair of down frames 12 branch off from the head pipe 11 to left and right and extend downward. A pair of main frames 13 branch off from the head pipe 11 to left and right and extend rearward, and a pair of body frames 14 extend downward from rear portions of the pair of main frames 13. A front portion of the engine 21 is supported by the pair of down frames 12, and a rear portion of the engine 21 is supported by the pair of main frames 13 and the pair of body frames 14.

The pair of main frames 13 form a tank rail located above the engine 21, and the pair of main frames 13 support a fuel tank 22 from below. Swing arm pivots are formed in lower halves of the pair of body frames 14, and swing arms 23 are swingably supported by the swing arm pivots. A pair of upper rails 15 extend rearward from upper portions of the pair of body frames 14, and a pair of lower rails 16 extend rearward and obliquely upward from middle positions of the pair of body frames 14 in an up-down direction. The pair of upper rails 15 and the pair of lower rails 16 support a seat (not illustrated) from below.

A pair of front forks 24 are steerably supported on the head pipe 11 via a steering shaft (not illustrated). A front wheel 25 is rotatably supported at lower portions of the front forks 24, and an upper part of the front wheel 25 is covered by a front fender (not illustrated). The swing arm 23 extends rearward from the body frame 14. A rear wheel 26 is rotatably supported at rear ends of the swing arms 23, and an upper part of the rear wheel 26 is covered by a rear fender (not illustrated). The engine 21 is connected to the rear wheel 26 via a chain drive type transmission mechanism, and power from the engine 21 is transmitted to the rear wheel 26 via the transmission mechanism.

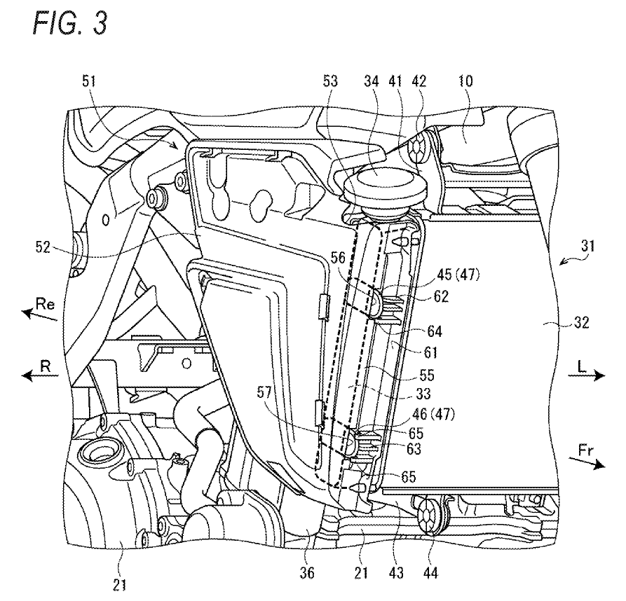

A radiator 31 is installed in front of the engine 21, and an inlet tank 33 (see FIG. 3) on a right side of the radiator 31 is covered from the side by a radiator cover 51. Here, the radiator 31 and the radiator cover 51 are not directly fixed to each other, thereby preventing abnormal noise caused by engine vibration being transmitted from the radiator 31 to the radiator cover 51. Even when the radiator 31 expands and contracts during engine cooling, fixing points between the radiator 31 and the radiator cover 51 will not be damaged. The radiator 31 and the radiator cover 51 are mounted independently, thereby improving maintainability.

A radiator cap 34 is provided in an upper portion of the inlet tank 33, and the radiator cap 34 is exposed to outside from an opening in an upper portion of the radiator cover 51. By attaching and detaching the radiator cap 34, refill of coolant to the inlet tank 33 and the like can be executed. An outer periphery of the radiator cap 34 is formed in a circular shape, and it is desirable to design an opening of the radiator cover 51 in an R-shape along the outer periphery of the radiator cap 34, but there is a risk that the radiator 31 and the radiator cover 51 will be misaligned and interfere with each other. Therefore, in the example, a positional relationship between the radiator 31 and the radiator cover 51 is maintained while not being fixed.

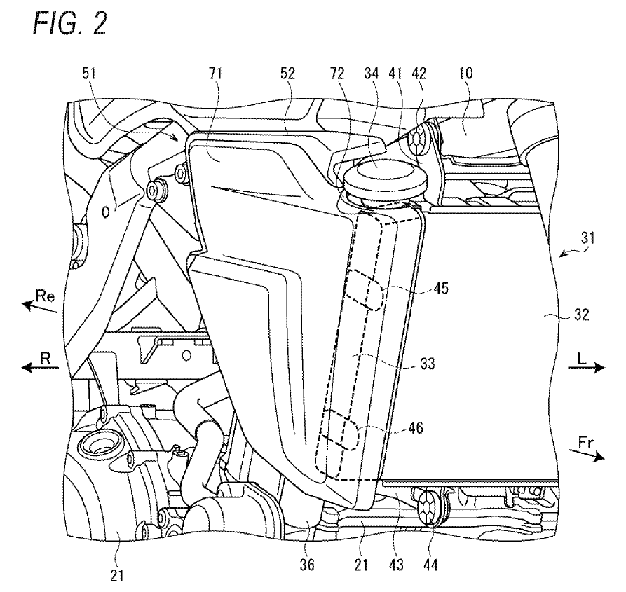

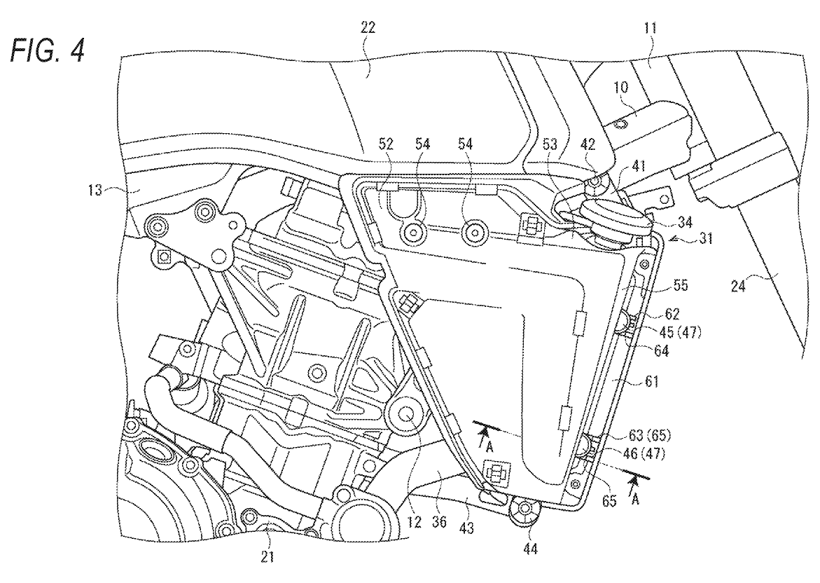

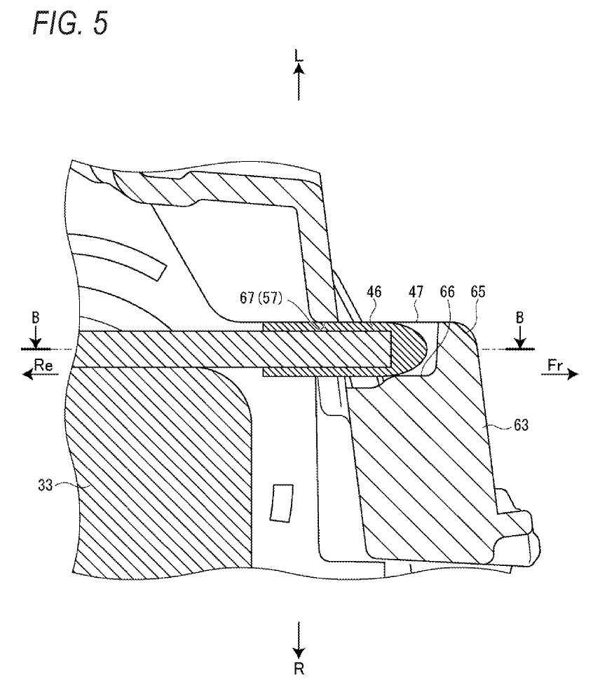

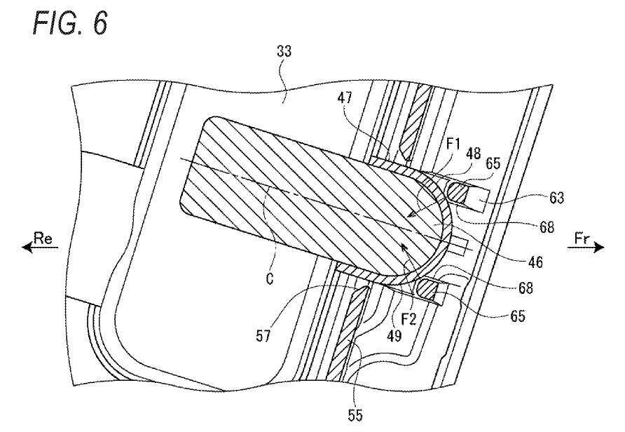

The installation structure of the radiator cover will be described with reference to FIGS. 2-6. FIGS. 2 and 3 are perspective views of the installation structure of radiator cover of the example. FIG. 4 is a right side view of the installation structure of the radiator cover of the example. FIG. 5 is a cross-sectional view of the installation structure of the radiator cover illustrated in FIG. 4 taken along a line A-A. FIG. 6 is a cross-sectional view of a restricting portion illustrated in FIG. 5 taken along a line B-B. FIGS. 3-6 illustrate a state in which an outer cover is removed from the radiator cover. In FIGS. 2 and 3, the inlet tank is illustrated by a broken line.

As illustrated in FIGS. 2 and 3, an upper stay 41 of the radiator 31 is fixed to the body frame 10 via a cushion material 42. A lower stay 43 of the radiator 31 is fixed to the engine 21 via a cushion material 44. The radiator 31 is floatingly fixed to the body frame 10 and the engine 21, thereby preventing the engine vibrations from being transmitted to the radiator 31. The inlet tank 33 and an outlet tank (not illustrated) are provided on both left and right sides of a radiator core 32 of the radiator 31. Coolant flows from the inlet tank 33 to the outlet tank, and heat of the coolant is released into the air while passing the radiator core 32.

The inlet tank 33 on the right side (one side) of the radiator 31 extends up and down. The radiator cap 34 is removably attached to a coolant inlet in the upper portion of the inlet tank 33. An inlet tube 36 is connected to an inlet pipe (not illustrated) behind a lower portion of the inlet tank 33. An upper protrusion 45 protrudes forward from an upper half of the inlet tank 33. A lower protrusion 46 protrudes forward from a lower half of the inlet tank 33. Tips of the upper protrusion 45 and the lower protrusion 46 are formed in a semicircular plate shape in a side view. The upper protrusion 45 and the lower protrusion 46 are covered by rubber caps 47 serving as friction materials.

The radiator cover 51 covers the inlet tank 33 of the radiator 31 from the right side, and is configured as a double structure including an inner cover 52 and an outer cover 71. The inner cover 52 is fixed to the fuel tank 22 via a pair of fixing members 54 (see FIG. 4). The outer cover 71 is attached to the inner cover 52 by pinning, latching, or the like. An opening 53 having a semicircular shape surrounding the radiator cap 34 is formed in an upper portion of the inner cover 52. A convex portion 72 having a semicircular shape along an outer peripheral surface of the radiator cap 34 is formed in an upper portion of the outer cover 71.

A front end portion of the inner cover (cover body) 52 is recessed inward in a vehicle width direction, and the inlet tank 33 is covered from front by a front surface portion 55 corresponding to a step of the inner cover 52. An upper insertion hole 56 for the upper protrusion 45 is formed in an upper half of the front surface portion 55. A lower insertion hole 57 for the lower protrusion 46 is formed in a lower half of the front surface portion 55. The upper insertion hole 56 and the lower insertion hole 57 are elongated holes extending in the up-down direction. Hole widths of the upper insertion hole 56 and the lower insertion hole 57 are formed to be larger than plate thicknesses of the upper protrusion 45 and the lower protrusion 46. The upper protrusion 45 extends forward through the upper insertion hole 56. The lower protrusion 46 extends forward through the lower insertion hole 57.

A side surface portion 61 projects forward from an inner edge of the front surface portion 55 of the inner cover 52. Three upper ribs 62 and three lower ribs 63 are provided at corners of the front surface portion 55 and the side surface portion 61. Upper halves of the front surface portion 55 and the side surface portion 61 are reinforced by the three upper ribs 62. Lower halves of the front surface portion 55 and the side surface portion 61 are reinforced by the three lower ribs 63. The three upper ribs 62 are aligned in the up-down direction perpendicular to a standing direction. The three upper ribs 62 are positioned at a height corresponding to the upper insertion hole 56. The three lower ribs 63 are aligned in the up-down direction perpendicular to the standing direction. The three lower ribs 63 are positioned at a height corresponding to the lower insertion hole 57.

Corners on a free end side of the upper two upper ribs 62 among the three upper ribs 62 are notched. An upper restricting portion 64 protrudes outward in the vehicle width direction from a corner on the free end side of the lowest upper rib 62. Forward displacement of the upper protrusion 45 that passed through the upper insertion hole 56 is restricted by the single upper restriction portion 64. A corner on the free end side of the middle lower rib 63 among the three lower ribs 63 is notched. A pair of lower restricting portions 65 protrude outward in the vehicle width direction from corners on the free end side of the uppermost and lowermost lower ribs 63. Forward displacement of the lower protrusion 46 that passed through the lower insertion hole 57 is restricted by the pair of lower restricting portions 65.

As illustrated in FIG. 4, the tip of the upper protrusion 45 covered with the rubber cap 47 is in contact with the single upper restricting portion 64. The tip of the lower protrusion 46 covered by the rubber cap 47 is in contact with the pair of lower restricting portions 65. The upper protrusion 45 is in frictional contact with the single upper restricting portion 64 via rubber, and the lower protrusion 46 is in frictional contact with the pair of lower restricting portions 65 via rubber, so that the radiator 31 and the radiator cover 51 are integrated and misalignment is effectively prevented. The radiator 31 and the radiator cover 51 move in synchronization, thereby reducing wear on the upper protrusion 45 and the lower protrusion 46 of the radiator 31 and the upper restricting portion 64 and the pair of lower restricting portions 65 of the radiator cover 51.

As illustrated in FIG. 5, three restraining portions 66 are formed in the three lower ribs 63 behind the pair of lower restricting portions 65, and project outward in the vehicle width direction. A width of the lower insertion hole 57 is narrowed by the three restraining portions 66, and the three restraining portions 66 are in contact with a side surface of the lower protrusion 46. The lower protrusion 46 is interposed between a hole edge 67 on an outer side of the lower insertion hole 57 in the vehicle width direction and the three restraining portions 66, thereby preventing displacement of the lower protrusion 46 in the lower insertion hole 57. The lower insertion hole 57 is larger than the lower protrusion 46, and even when the lower protrusion 46 is formed in a thin shape, deviation in a thickness direction of the lower protrusion 46 within the lower insertion hole 57 is prevented. The three upper ribs 62 also have similar restraining portions.

As illustrated in FIG. 6, while the radiator cover 51 is installed, a central axis C of the lower protrusion 46 (rubber cap 47) is oriented forward and slightly tilted downward. The tip of the lower protrusion 46 is tapered forward closer to the central axis C. In the example, the tip of the lower protrusion 46 is formed in a semicircular shape in the side view. When the tip of the lower protrusion 46 (rubber cap 47) is divided into an upper inclined surface 48 and a lower inclined surface 49 with the center axis C as a boundary, the upper inclined surface 48 is inclined downward while bulging radially outward from an upper end toward the front side, and the lower inclined surface 49 is inclined upward while bulging radially outward from a lower end toward the front side.

As described above, the pair of lower restricting portions 65 are provided near the lower insertion hole 57 and spaced apart in the up-down direction. The pair of lower restricting portions 65 are formed to have a rectangular shape in a cross section. Facing surfaces 68 of the pair of lower restricting portions 65 are formed parallel to the central axis C of the lower protrusion 46. A distance between the facing surfaces 68 of the pair of lower restricting portions 65 is smaller than a height of the lower protrusion 46 (rubber cap 47). Therefore, the pair of lower restricting portions 65 are each in contact with the upper inclined surface 48 and the lower inclined surface 49 while sandwiching the central axis C, and the pair of lower restricting portions 65 stably receive the lower protrusion 46, thereby effectively preventing misalignment between the radiator 31 and the radiator cover 51.

More specifically, the upper inclined surface 48 is received by a corner of one of the lower restricting portions 65, and the lower inclined surface 49 is received by a corner of the other lower restricting portion 65. A reaction force as illustrated by an arrow F1 acts on the upper inclined surface 48, and a backward component of the reaction force restricts the forward displacement of the lower protrusion 46, while a downward component of the reaction force restricts the upward displacement of the lower protrusion 46. A reaction force as illustrated by an arrow F2 acts on the lower inclined surface 49, and a backward component of the reaction force restricts the forward displacement of the lower protrusion 46, while an upward component of the reaction force restricts the downward displacement of the lower protrusion 46. Accordingly, both the forward displacement and the vertical displacement of the lower protrusion 46 are restricted.

As described above, according to the installation structure of the radiator cover 51 of the example, the forward displacement of the upper protrusion 45 and the lower protrusion 46 is restricted by the upper restricting portion 64 and the pair of lower restricting portions 65, thereby preventing misalignment between the radiator 31 and the radiator cover 51. Even when the radiator 31 and the radiator cover 51 are not fixed, a positional relationship between the radiator 31 and the radiator cover 51 is maintained, so the radiator cover 51 does not interfere with the radiator cap 34 even when the radiator cover 51 is formed along the radiator cap 34. Therefore, the radiator cover 51 can be formed along the radiator cap 34 and with a slim design.

In the example, the inlet tank is provided with the upper protrusion and the lower protrusion as protrusions, but the inlet tank only needs at least one protrusion. The radiator cover is provided with the upper insertion hole and the lower insertion hole as insertion holes, but the radiator cover only needs at least one insertion hole matching with the protrusion. Similarly, the radiator cover is provided with the upper restricting portion and the lower restricting portions as restricting portions, but the radiator cover only needs at least one restricting portion matching with the protrusion.

In the example, the upper protrusion and the lower protrusion are formed in a plate shape, but the shape of the protrusions is not particularly limited. Although the upper insertion hole and the lower insertion hole are formed as elongated holes, the shape of the insertion holes is not particularly limited as long as the protrusions can be inserted.

In the example, the upper restricting portion and the lower restricting portions are in contact with the tips of the upper protrusion and the lower protrusion, but as long as the restricting portions can regulate displacement of the protrusions, a small gap may be provided between the restricting portions and the protrusions.

In the example, the upper protrusion and the lower protrusion are covered by rubber caps as friction materials, but friction materials other than the rubber caps may be fitted to the protrusions. As long as the forward displacement of the protrusions can be restricted by the restricting portions, the protrusions do not need to be fitted with friction materials.

In the example, the radiator cover is provided with the pair of lower restricting portions as restricting portions, but the number of restricting portions is not particularly limited. The forward displacement of the protrusion may be restricted by one restricting portion, or the forward displacement of the protrusion may be restricted by three or more restricting portions.

The installation structure of the radiator cover 51 of the example is not limited to the straddle-type vehicle described above, and may be adopted in other types of straddle-type vehicles. The term "straddle-type vehicle" is not limited to a vehicle on which a driver rides while straddling on a seat, but also includes a scooter-type vehicle on which the driver rides without straddling on the seat.

As described above, according to a first aspect, provided is a radiator cover (51) for covering one side of a radiator (31) on a radiator cap (34) side in which the radiator is installed in front of an engine (21) of a straddle-type vehicle (1), the radiator cover including a cover body (inner cover 52) having an insertion hole (upper insertion hole 56, lower insertion hole 57) formed for receiving a protrusion (upper protrusion 45, lower protrusion 46) protruding forward from the one side (inlet tank 33), and a restricting portion (upper restricting portion 64, lower restricting portions 65) that restricts forward displacement of the protrusion that extends through the insertion hole. According to such a configuration, the restricting portion restricts the forward displacement of the protrusion, thereby preventing misalignment between the radiator and the radiator cover. Even when the radiator and the radiator cover are not fixed, a positional relationship between the radiator and the radiator cover is maintained, so the radiator cover does not interfere with the radiator cap even when the radiator cover is formed along the radiator cap. Accordingly, the radiator cover can be formed along the radiator cap and with a slim design.

According to a second aspect, in the first aspect, the restricting portion comes in contact with a tip of the protrusion. According to such a configuration, the restricting portion and the protrusion are in contact with each other, so that the radiator and the radiator cover are integrated and misalignment is effectively prevented. The radiator and the radiator cover move in synchronization, thereby reducing wear on the restricting portion and the protrusion.

According to a third aspect, in the second aspect, the restricting portion comes in contact with the tip of the protrusion via a friction material (rubber cap 47). According to such a configuration, the restricting portion and the protruding portion are in frictional contact with each other, so that the radiator and the radiator cover are further integrated and misalignment is effectively prevented.

According to a fourth aspect, in any one of the first to third aspects, a restraining portion (66) is formed for restraining displacement within the insertion hole of the protrusion that passed through the insertion hole. According to such a configuration, deviation of the protrusion within the insertion hole is reduced even when the insertion hole is relatively large compared to the protrusion.

According to a fifth aspect, in the second aspect or the third aspect, the restricting portion is a pair of restricting portions (lower restricting portions 65) that come in contact with two points spaced apart on the tip of the protrusion. According to such a configuration, the protrusion is stably received by the pair of restricting portions, thereby effectively preventing misalignment between the radiator and the radiator cover.

According to a sixth aspect, in the fifth aspect, the tip of the protrusion is tapered forward closer to a central axis, and the pair of restricting portions come in contact with two points of the tip of the protrusion that interpose the central axis. According to such a configuration, both the forward displacement of the protrusion and the displacement of the protrusion in a direction perpendicular to the central axis of the protrusion are restricted, thereby further effectively preventing misalignment between the radiator and the radiator cover.

Although the present example is described, other examples may be made by combining the above-described example and modification examples in whole or in part.

The technology of the present invention is not limited to the above-described example, and may be variously changed, substituted, or modified within the scope that does not deviate from the spirit and intent of the technical idea. When the technical idea can be realized in a different way due to technological advances or derived other technologies, the idea may be implemented using such methods. Therefore, the claims cover all embodiments that may fall within the scope of the technical concept.

What is claimed is:

1. A radiator cover for covering one side of a radiator on a radiator cap side in which the radiator is installed in front of an engine of a straddle-type vehicle, the radiator cover comprising:
a cover body having an insertion hole configured to receive a protrusion protruding forward from the one side; and
a restricting portion configured to restrict a forward displacement of the protrusion that extends through the insertion hole.

2. The radiator cover according to claim 1, wherein the restricting portion is configured to come in contact with a tip of the protrusion.

3. The radiator cover according to claim 2, wherein the restricting portion is configured to come in contact with the tip of the protrusion via a friction material.

4. The radiator cover according to claim 1, further comprising a restraining portion configured to restrain a displacement within the insertion hole of the protrusion that passed through the insertion hole.

5. The radiator cover according to claim 2, wherein the restricting portion is a pair of restricting portions configured to come in contact with two points spaced apart on the tip of the protrusion.

6. The radiator cover according to claim 5, wherein the tip of the protrusion is tapered forward closer a central axis, and the pair of restricting portions are configured to come in contact with two points of the tip of the protrusion that interpose the central axis.
